(19) United States
(12) Patent Application Publication
(10) Pub. No.: US 2025/0364188 A1
(43) Pub. Date: Nov. 27, 2025

(54) SOLID ELECTROLYTIC CAPACITOR AND METHOD FOR PRODUCING SOLID ELECTROLYTIC CAPACITOR

(71) Applicant: Tokin Corporation, Miyagi (JP)

(72) Inventors: Takahiro Suzuki, Miyagi (JP); Masami Ishijima, Miyagi (JP); Tadamasa Asami, Miyagi (JP)

(73) Assignee: Tokin Corporation, Miyagi (JP)

(21) Appl. No.: 19/217,376

(22) Filed: May 23, 2025

(30) Foreign Application Priority Data
May 27, 2024 (JP) 2024-085554

(51) Int. Cl. H01G 9/025; H01G 9/00; H01G 9/15

(52) U.S. Cl. CPC H01G 9/025; H01G 9/0036; H01G 9/15

(57) ABSTRACT

A solid electrolytic capacitor has a high withstand voltage, including: a porous anode body including a valve metal and a dielectric oxide film layer formed on a surface of the valve metal; and an electrolyte layer formed on a surface of the dielectric oxide film layer. The electrolyte layer includes a first conductive polymer layer formed by chemical polymerization and in contact with the dielectric oxide film layer, a second conductive polymer layer formed by electrolytic polymerization and formed on a side opposite to the dielectric oxide film layer with respect to the first conductive polymer layer, and a barrier layer having conductivity and formed between the first conductive polymer layer and the second conductive polymer layer.

10 The barrier layer is configured to prevent a conductive polymer layer from being formed by electrolytic polymerization in a region closer to the anode body than the barrier layer.

### CROSS-REFERENCE TO RELATED APPLIATIONS

This application is a new U.S. Patent Application which claims priority to Japanese Patent Application No. 2024-085554, filed on May 2, 2024, the content of which is hereby incorporated by reference in its entirety.

### BACKGROUND OF THE INVENTION

### Field of the Invention

The present disclosure relates to a solid electrolytic capacitor and a method for producing a solid electrolytic capacitor.

### Description of Related Art

A solid electrolytic capacitor is used as a capacitor having a small size and a high capacity to be used in an electronic device or the like. Patent Literature 1 describes a method for preparing a solid electrolytic capacitor excellent in electrostatic capacity (Cs) and equivalent series resistance (ESR) by forming a conductive polymer layer by electrolytic polymerization.

### CITATION LIST

### Patent Literature

Patent Literature 1: JP2012-89542A

### SUMMARY OF THE INVENTION

In recent years, a capacitor having a high withstand voltage in addition to a small size and a high capacity has been desired.

An object of the present disclosure is to provide a solid electrolytic capacitor having a high withstand voltage.

A solid electrolytic capacitor according to an embodiment of the present disclosure includes:
a porous anode body including a valve metal and a dielectric oxide film layer formed on a surface of the valve metal; and
an electrolyte layer formed on a surface of the dielectric oxide film layer, wherein
the electrolyte layer includes
   a first conductive polymer layer formed by chemical polymerization and in contact with the dielectric oxide film layer,
   a second conductive polymer layer formed by electrolytic polymerization and formed on a side opposite to the dielectric oxide film layer with respect to the first conductive polymer layer, and
   a barrier layer having conductivity and formed between the first conductive polymer layer and the second conductive polymer layer, and
the barrier layer is configured to prevent a conductive polymer layer from being formed by electrolytic polymerization in a region closer to the anode body than the barrier layer.

A method for producing a solid electrolytic capacitor according to an embodiment of the present disclosure includes:
a step of forming a first conductive polymer layer on a surface of a porous anode body by chemical polymerization, the anode body including a valve metal and a dielectric oxide film layer formed on a surface of the valve metal;
a step of forming a barrier layer having conductivity on the first conductive polymer layer; and
a step of forming a second conductive polymer layer on the barrier layer by electrolytic polymerization.

According to the present disclosure, a solid electrolytic capacitor having a high withstand voltage can be provided.

### BRIEF DESCRIPTION OF THE DRAWINGS

Exemplary embodiment(s) of the present invention will be described in detail based on the following figures, wherein:

FIG. 1 is a cross-sectional view showing a solid electrolytic capacitor according to an embodiment of the present disclosure.

FIG. 2 is a schematic cross-sectional view showing an electrolyte layer of the solid electrolytic capacitor according to the embodiment of the present disclosure.

FIG. 3 is a schematic cross-sectional view showing an electrolyte layer of a solid electrolytic capacitor according to a first related-art example.

FIG. 4 is a schematic cross-sectional view showing an electrolyte layer of a solid electrolytic capacitor according to a second related-art example.

### DETAILED DESCRIPTION OF THE INVENTION

Specific examples of a solid electrolytic capacitor and a method for producing a solid electrolytic capacitor according to the present disclosure are described below with reference to the drawings, but the present disclosure is not limited to these examples.

### Configuration of Solid Electrolytic Capacitor

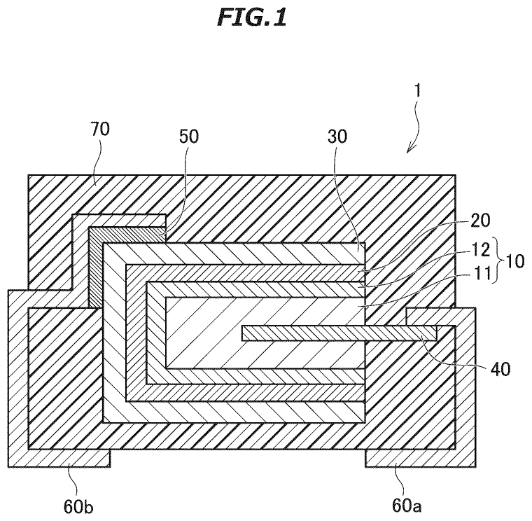

FIG. 1 is a cross-sectional view showing a solid electrolytic capacitor 1 according to an embodiment of the present disclosure. As shown in FIG. 1, the solid electrolytic capacitor 1 includes an anode body 10, an electrolyte layer 20, and a cathode layer 30. The solid electrolytic capacitor 1 according to the present embodiment can be formed by sequentially stacking the electrolyte layer 20 and the cathode layer 30 on the anode body 10.

The anode body 10 is porous and includes a valve metal 11 and a dielectric oxide film layer 12 formed on a surface of the valve metal 11. The valve metal 11 is, for example, a sintered body containing fine particles of the valve metal or a metal porous body subjected to a surface expansion treatment by roughening. Examples of the type of the valve metal 11 include at least one selected from the group consisting of aluminum, tantalum, niobium, tungsten, titanium, and zirconium, or an alloy of these valve metals. Among these, at least one valve metal selected from the group consisting of aluminum, tantalum, and niobium is preferred.

The dielectric oxide film layer 12 is an oxide film formed by oxidizing the surface of the valve metal 11. Specifically, the dielectric oxide film layer 12 can be formed on the surface of the valve metal 11 by electrolytically oxidizing the valve metal 11 in an aqueous solution containing adipic acid, citric acid, phosphoric acid, or a salt thereof. The dielectric oxide film layer 12 is also formed in a pore portion of the anode body 10 by the electrolytic oxidation. A thickness of the dielectric oxide film layer 12 can be appropriately adjusted based on a voltage during the electrolytic oxidation.

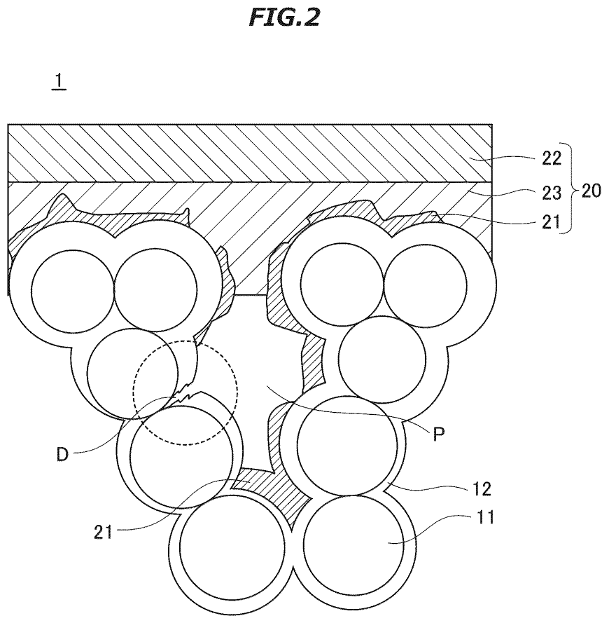

The electrolyte layer 20 is made of a solid electrolyte such as a conductive polymer. In the present embodiment, the electrolyte layer 20 includes a first conductive polymer layer 21, a second conductive polymer layer 22, and a barrier layer 23 (see FIG. 2). The first conductive polymer layer 21 is formed on a surface of the dielectric oxide film layer 12. The second conductive polymer layer 22 is formed on a side opposite to the dielectric oxide film layer 12 with respect to the first conductive polymer layer 21.

Examples of a conductive polymer constituting the first conductive polymer layer 21 or the second conductive polymer layer 22 include a conductive polymer containing thiophene, aniline, pyrrole, or a derivative thereof as a repeating unit, and a combination of two or more thereof. The conductive polymer may be doped with a dopant having an anion group or a salt thereof.

In the solid electrolytic capacitor 1 according to the present embodiment, the first conductive polymer layer 21 is formed by chemical polymerization. The second conductive polymer layer 22 is formed by electrolytic polymerization. The first conductive polymer layer 21 has a thickness of, for example, 1 μm or more and 300 μm or less. The second conductive polymer layer 22 has a thickness of, for example, 1 μm or more and 300 μm or less.

The barrier layer 23 is formed between the first conductive polymer layer 21 and the second conductive polymer layer 22. The barrier layer 23 has conductivity and may be made of a conductive polymer. The barrier layer 23 is formed by a method other than the chemical polymerization and the electrolytic polymerization, and is thereby distinguished from the first conductive polymer layer 21 and the second conductive polymer layer 22. The barrier layer 23 can be formed, for example, by applying and drying a conductive polymer dispersion liquid or a conductive polymer solution. For example, a PEDOT/PSS dispersion liquid, which is poly(3,4-ethylenedioxythiophene) (PEDOT) doped with polystyrene sulfonic acid (PSS) as a dopant, can be used. In addition, a self-doping type soluble conductive polymer solution having an anion group having a dopant function in a π-conjugated polymer may be used. The barrier layer 23 prevents a conductive polymer layer from being formed by electrolytic polymerization in a region closer to the anode body 10 than the barrier layer 23. Details of the electrolyte layer 20 in the present embodiment is to be described later.

The cathode layer 30 is provided on the electrolyte layer 20. The cathode layer 30 may include, for example, a carbon layer and a silver layer stacked on the carbon layer, but is not particularly limited thereto. The cathode layer 30 is connected to a lead frame 60b. For example, as shown in FIG. 1, the cathode layer 30 is connected to lead frame 60b at a cathode side via a conductive adhesive 50.

An anode lead 40 is a lead for ensuring electrical connection between the anode body 10 and the outside. The anode lead 40 may be a metal wire embedded in the valve metal 11, and is, for example, a metal wire having a type same as that of the valve metal 11. The anode lead 40 is connected to a lead frame 60a at an anode side. The anode lead 40 and the lead frame 60a are connected to each other by welding, for example.

The solid electrolytic capacitor 1 is obtained by connecting the anode lead 40 to the lead frame 60a and connecting the cathode layer 30 to the lead frame 60b, and then forming an exterior resin 70 using a molding press or the like.

### Method for Forming Electrolyte Layer

Examples of a method of forming the conductive polymer layer constituting the electrolyte layer 20 mainly include chemical polymerization, electrolytic polymerization, and application and drying of a conductive polymer dispersion liquid or solution. Regarding each of the forming methods, the outline of the method and the characteristics of the electrolyte layer to be formed are described. In the following description, a conductive polymer layer formed by chemical polymerization may be referred to as a “chemically polymerized layer”, and a conductive polymer layer formed by electrolytic polymerization may be referred to as an “electrolytically polymerized layer”. In addition, a method of applying and drying a conductive polymer dispersion liquid or solution may be referred to as “solution application”.

The chemical polymerization and the electrolytic polymerization are methods for forming a conductive polymer by immersing an object such as an anode body in a monomer solution to polymerize the monomer on a surface of the object (in situ polymerization). When the porous anode body is immersed in the monomer solution, the monomer enters a pore P of the anode body, so that the electrolyte layer can be formed inside the anode body in both the chemical polymerization and the electrolytic polymerization. When the electrolyte layer is formed inside the anode body, a contact area between the dielectric oxide film layer and the electrolyte layer increases, so that a high-capacity capacitor can be obtained.

In the chemical polymerization, an object such as an anode body is immersed in an oxidant solution and then dried to form an oxidant crystal. Next, the object on which the oxidant crystal is formed is immersed in a monomer solution to bring the monomer into contact with the oxidant crystal to cause a polymerization reaction of the monomer, thereby forming a conductive polymer layer. The chemically polymerized layer has relatively low uniformity as a film, and tends to have a three-dimensional shape with many irregularities and a low density.

In the electrolytic polymerization, utilizing an electrochemical reaction, a current is passed through a solution containing a monomer and a supporting electrolyte to polymerize the monomer, thereby obtaining a conductive polymer layer. The electrolytically polymerized layer has high uniformity as a film and a high density. Further, the film obtained by the electrolytic polymerization has high dimensional stability, and the electrolyte layer can be uniformly formed also at corners of the object. Therefore, a smaller capacitor can be produced by utilizing the electrolytic polymerization. On the other hand, in order to perform the electrolytic polymerization, it is necessary to pass a current through the monomer solution, but since it is difficult to pass a current through the dielectric oxide film layer, it is difficult to form an electrolytically polymerized layer directly on the dielectric oxide film layer. Therefore, a method of forming a conductive polymer layer on the dielectric oxide film layer by the chemical polymerization or the solution application before the electrolytic polymerization is adopted.

On the other hand, the conductive polymer dispersion liquid or the conductive polymer solution is less likely to enter the pore of the anode body than the monomer solution. Therefore, in the case of forming the electrolyte layer by the solution application, unlike the case of the chemical polymerization or the electrolytic polymerization, the electrolyte layer is less likely to be formed inside the anode body. In addition, in the solution application, a film having high uniformity can be obtained, but unlike the electrolytic polymerization, it is difficult to form an electrolyte layer at the corners of the object. Therefore, it is necessary to increase a thickness of the electrolyte layer in order to reliably form the electrolyte layer at the corners, which is considered to be disadvantageous for forming a smaller capacitor.

### Detailed Configuration of Electrolyte Layer

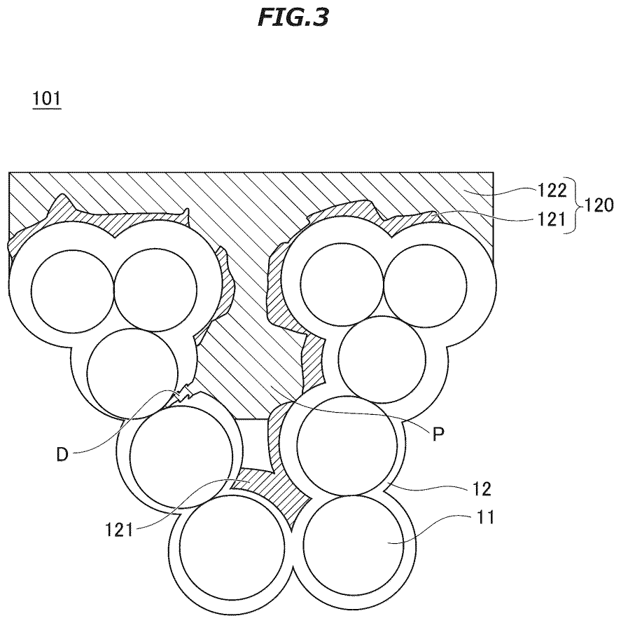

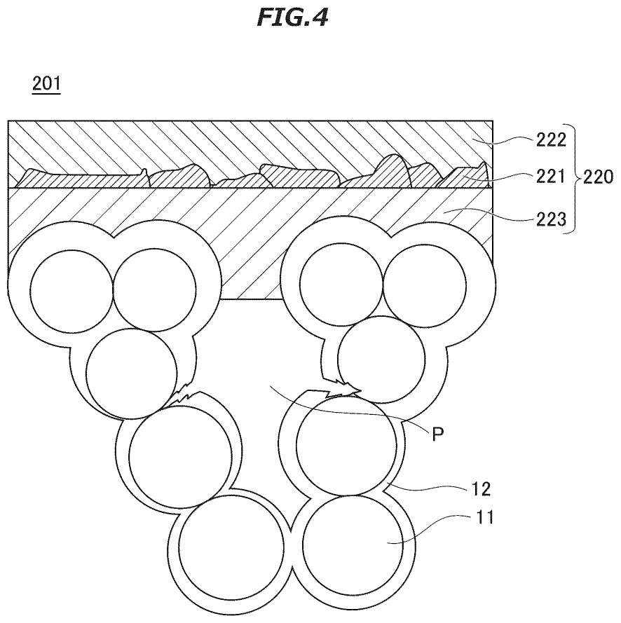

Next, a configuration of the electrolyte layer 20 in the present embodiment is described in more detail in comparison with a related-art example. FIG. 2 shows a cross-sectional structure of the solid electrolytic capacitor 1 according to the present embodiment. FIG. 3 shows a cross-sectional structure of a solid electrolytic capacitor 101 according to a first related-art example. FIG. 4 shows a cross-sectional structure of a solid electrolytic capacitor 201 according to a second related-art example. In FIGS. 2 to 4, a porous structure including the valve metal 11 and the dielectric oxide film layer 12 formed on the surface of the valve metal 11 is shown in common. Further, as the electrolyte layer, the electrolyte layer 20 is shown in FIG. 2, an electrolyte layer 120 is shown in FIG. 3, and an electrolyte layer 220 is shown in

FIG. 4. FIGS. 2 to 4 are enlarged cross-sectional views of the vicinity of a boundary between the anode body 10 and each of the electrolyte layers 20, 120, and 220.

### First Related-Art Example

First, the solid electrolytic capacitor 101 according to the first related-art example shown in FIG. 3 is described. The electrolyte layer 120 of the solid electrolytic capacitor 101 includes a chemically polymerized layer 121 and an electrolytically polymerized layer 122.

As described above, according to the chemical polymerization, the conductive polymer layer is formed not only on the surface of the anode body 10 but also inside the anode body 10. Therefore, in the solid electrolytic capacitor 101 according to the first related-art example, as shown in FIG. 3, the chemically polymerized layer 121 is also formed in the pore P of the anode body 10. In addition, the chemically polymerized layer 121 does not have high uniformity as a film. Therefore, as schematically shown in FIG. 3, even when the chemically polymerized layer 121 is formed on the dielectric oxide film layer 12, the dielectric oxide film layer 12 is not completely covered with only the chemically polymerized layer 121 and is partially exposed.

In the first related-art example, the electrolytically polymerized layer 122 is formed after the chemically polymerized layer 121 is formed. In the case of the electrolytic polymerization, similar to the chemical polymerization, the electrolytically polymerized layer 122 is formed not only on the surface of the anode body 10 but also in the pore P. Therefore, the electrolytically polymerized layer 122 is partially formed on the chemically polymerized layer 121, and is directly formed on the dielectric oxide film layer 12 in a portion where the chemically polymerized layer 121 is not formed.

As shown in FIG. 3, the dielectric oxide film layer 12 is formed on the surface of the valve metal 11, but there is a defect portion D where the dielectric oxide film layer 12 is not locally present and the valve metal 11 is exposed. In the first related-art example, the conductive polymer layer (the chemically polymerized layer 121 or the electrolytically polymerized layer 122) can also be formed in the defect portion D present in the pore P as shown in FIG. 3. When the conductive polymer layer is formed in the defect portion D, a current can flow in the corresponding portion without passing through the dielectric oxide film layer 12, so that a withstand voltage as a capacitor may decrease.

However, in the case of the chemical polymerization, since the uniformity of the chemically polymerized layer 121 formed is not high, even when the chemically polymerized layer 121 is formed in the defect portion D, the chemically polymerized layer 121 formed in the defect portion D can be oxidized and insulated by performing a local chemical conversion treatment (for example, application of a weak current) later, and a decrease in withstand voltage can be prevented. On the other hand, since the electrolytically polymerized layer 122 has uniformity higher than that of the chemically polymerized layer 121, in the case where the electrolytically polymerized layer 122 is formed in the defect portion D, it is difficult to perform a treatment of locally insulating the electrolytically polymerized layer 122. As a result, as shown in FIG. 3, a portion where the electrolytically polymerized layer 122 and the valve metal 11 are in direct contact with each other is generated in the defect portion D, which leads to a decrease in withstand voltage. Therefore, in a configuration having a combination of the chemically polymerized layer 121 and the electrolytically polymerized layer 122 as in the first related-art example, it is difficult to obtain a high withstand voltage.

### Second Related-Art Example

Next, the solid electrolytic capacitor 201 according to the second related-art example shown in FIG. 4 is described. The solid electrolytic capacitor 201 includes the electrolyte layer 220 formed by firstly forming a conductive polymer layer 223 on the surface of the anode body 10 by solution application, and then sequentially stacking a chemically polymerized layer 221 and an electrolytically polymerized layer 222.

In the solution application, since a conductive polymer dispersion liquid or a conductive polymer solution does not enter the pore P of the anode body 10, the conductive polymer layer 223 is formed only on the surface of the anode body 10 as shown in FIG. 4. Next, the chemically polymerized layer 221 and the electrolytically polymerized layer 222 are sequentially formed, but since the conductive polymer layer 223 is already formed, the monomer solution does not enter the inside of the pore P, and thus the chemically polymerized layer or the electrolytically polymerized layer cannot be formed inside the pore P. Therefore, in a capacitor having the configuration of the second related-art example shown in FIG. 4, a contact area between the dielectric oxide film layer 12 and the electrolyte layer 220 is smaller, and as a result, the capacity decreases and equivalent series resistance (ESR) increases.

### Present Embodiment

Next, the solid electrolytic capacitor 1 according to the embodiment of the present disclosure shown in FIG. 2 is described. As shown in FIG. 2, the solid electrolytic capacitor 1 includes the electrolyte layer 20 including the first conductive polymer layer 21 (hereinafter referred to as the chemically polymerized layer 21) formed by chemical polymerization, the second conductive polymer layer 22 (hereinafter referred to as the electrolytically polymerized layer 22) formed by electrolytic polymerization, and the barrier layer 23 formed by solution application.

In the present embodiment, similar to the first related-art example shown in FIG. 3, the chemically polymerized layer 21 is formed in the pore P of the anode body 10.

The solid electrolytic capacitor 1 according to the present embodiment is different from the first related-art example shown in FIG. 3 in that the barrier layer 23 is formed after the chemically polymerized layer 21 is formed and before the electrolytically polymerized layer 22 is formed. As described above, since the conductive polymer dispersion liquid or the conductive polymer solution does not enter the pore P, the barrier layer 23 formed by solution application is formed only on the surface of the anode body 10 as shown in FIG. 2.

When the electrolytically polymerized layer 22 is formed after the barrier layer 23 is formed, the presence of the barrier layer 23 prevents the electrolytically polymerized layer 22 from being formed closer to the anode body 10 than the barrier layer 23. Therefore, the electrolytically polymerized layer 22 is not formed in the pore P of the anode body 10, and the formation of the electrolytically polymerized layer 22 in the defect portion D can be avoided.

According to the configuration in the present embodiment, since the formation of the electrolytically polymerized layer in the defect portion D is prevented as compared with the first related-art example shown in FIG. 3, the withstand voltage of the capacitor is improved.

In addition, as compared with the second related-art example shown in FIG. 4, since the chemically polymerized layer 21 is formed in the pore P, the capacity is large. In addition, since the electrolytically polymerized layer 22 is formed on the barrier layer 23 having a relatively flat surface instead of the chemically polymerized layer 21 having many irregularities, a more uniform film having excellent dimensional accuracy can be obtained, which is suitable for forming a small capacitor.

In the case of forming the barrier layer 23 by applying a conductive polymer dispersion liquid, a particle diameter of a conductive polymer contained in the conductive polymer dispersion liquid is preferably 5 nm or more. Here, the particle diameter of the conductive polymer is d50 (median diameter) in a number distribution. The particle diameter of the conductive polymer can be measured based on a dynamic light scattering method. The upper limit of the particle diameter of the conductive polymer is not particularly limited, and may be, for example, 100 nm. The particle diameter of the conductive polymer can be adjusted by, for example, strength of an external force to be applied during a dispersion treatment of the conductive polymer dispersion liquid, a temperature during the polymerization, a charged amount and a speed of the oxidant, and a polymerization rate that changes depending on stirring conditions.

The barrier layer 23 preferably has a water absorption amount of 50 mass % or less in an atmosphere at a temperature of 85° C. and a humidity of 85% RH for 24 hours. Since the water absorption amount of the barrier layer 23 is small, swelling or peeling of the barrier layer 23 is less likely to occur when the barrier layer 23 is immersed in an electrolytic polymerization solution, and deterioration of the ESR and an increase in dimension can be avoided. The barrier layer 23 preferably has a contact angle with respect to water of 10 degrees or more. When the contact angle with respect to water is 10° C. or more, hydrophobicity is sufficiently high, and swelling and peeling of the barrier layer 23 when the barrier layer 23 is immersed in an electrolytic polymerization solution can be avoided. Examples of a method of reducing the water absorption amount or increasing the contact angle with respect to water include a method of using PEDOT (poly(3,4-ethylenedioxythiophene)) doped with PSS (poly(4-styrenesulfonic acid)) as the barrier layer 23 and then reducing a ratio of PSS which is a hydrophilic dopant, a method of using a hydrophobic anion having a long-chain alkyl group or phenyl group as a dopant, and a method of adding a hydrophobic binder resin to a dispersion liquid. In the case of adding a binder resin, examples of a resin to be added include a fluorine-based resin, a polyester resin, an oxetane resin, a polyurethane resin, a polyimide resin, a styrene-butadiene-based rubber, a melamine resin, a silicon resin, an alkyd resin, a phenol resin, an epoxy resin, a butyral resin, an acrylic resin, and a silicone resin. In the present disclosure, as a method for modifying properties of the barrier layer 23 such as the water absorption amount and the contact angle with respect to water, any of the above method may be used, and two or more methods may be combined. Note that, the properties of the barrier layer 23 such as the water absorption amount and the contact angle with respect to water described above may be regarded as the same as properties of a single film formed of a material same as that of the barrier layer 23, and it is not necessary to directly measure the properties of the barrier layer 23 incorporated in the capacitor.

A ratio of an area where the barrier layer 23 is formed to an area of the planes of the anode body 10 where the electrolyte layer 20 is formed (hereinafter sometimes referred to as a “barrier layer coverage”) is preferably 50% or more. The area of the planes of the anode body 10 here is not an actual surface area in consideration of the pore, but the area of the planes when the anode body 10 is viewed as a simple shape such as a rectangular parallelepiped with the pore ignored. By increasing the barrier layer coverage, the formation of the electrolytically polymerized layer 22 on the anode body 10 can be more reliably prevented. The barrier layer coverage is more preferably 80% or more, and most preferably 100%.

The first conductive polymer layer (chemically polymerized layer) 21 is preferably subjected to a primer treatment. By performing the primer treatment, adhesion to the barrier layer 23 to be stacked thereafter can be improved, and the barrier layer coverage can be increased. A primer material is not particularly limited, and for example, a polyvalent amine or a salt thereof can be used. More specific examples thereof include 1,3-diaminopropane, 1,4-diaminobutane, 1,5-diaminopentane, 1,6-diaminohexane, 1,7-diaminoheptane, 1,8-diaminooctane, 1,9-diaminononane, 1,10-diaminodecane, and a derivative thereof. The primer treatment can be performed by, for example, immersing the chemically polymerized layer 21 in an amine aqueous solution exemplified above, and then performing drying.

The barrier layer 23 preferably has a sufficiently low sheet resistance. Specifically, in the case of forming the barrier layer 23 by solution application, the sheet resistance of a film obtained by applying and drying the conductive polymer dispersion liquid or the conductive polymer solution used for forming the barrier layer 23 is preferably 100 Ω/□ or less. Since the sheet resistance of the barrier layer 23 is sufficiently low, formation failure of the electrolytically polymerized layer 22 and an increase in ESR can be avoided.

The barrier layer 23 has a thickness of preferably 30 μm or less, more preferably 20 μm or less, and still more preferably 10 μm or less. When the thickness of the barrier layer 23 is within the above range, the formation of the electrolytically polymerized layer 22 on the anode body 10 side can be satisfactorily prevented while avoiding an increase in ESR. The lower limit of the thickness of the barrier layer 23 is not particularly limited, and may be, for example, 0.1 μm, or 0.5 μm.

The solid electrolytic capacitor 1 preferably includes, as the cathode layer 30, a carbon layer formed on the second conductive polymer layer 22 and a silver layer formed on the carbon layer, and the silver layer preferably has a surface line roughness Ra of 3.0 μm or less. When the silver layer is flat, the dimensional stability is high, and a small capacitor is easily formed. Since the surface line roughness Ra of the silver layer is reduced as the surface of the electrolytically polymerized layer 22 formed thereunder is flatter, the surface line roughness Ra of the silver layer can be easily set within the above range by adopting the configuration of the electrolyte layer 20 according to the present disclosure.

Whether a finished capacitor has the configuration of the solid electrolytic capacitor 1 according to the present disclosure can be checked by disassembling the capacitor and performing observation and evaluation. The finished capacitor may be, for example, a resin-molded capacitor.

### EXAMPLES

Hereinafter, the solid electrolytic capacitor according to the present disclosure is described in more detail with reference to specific Examples, but the present disclosure is not limited to these Examples.

### Preparation of Polymer Film

First, in order to evaluate the properties of a conductive polymer layer used as a barrier layer of a solid electrolytic capacitor, a polymer film was prepared alone using a conductive polymer dispersion liquid used for forming the barrier layer.

### Experimental Example 1

As a conductive polymer dispersion liquid A, a dispersion liquid in which PEDOT/PSS (a conductive polymer in which poly(3,4-ethylenedioxythiophene) (PEDOT) was doped with poly(4-styrenesulfonic acid) (PSS)), a polyester resin (PLASCOAT (registered trademark) Z-687, manufactured by GOO CHEMICAL CO., LTD.), and ethylene glycol were dispersed in water was prepared. Based on JIS Z8828:2019, the particle diameter of the conductive polymer contained in the dispersion liquid was measured by a dynamic light scattering method using a dynamic light scattering measurement device (ESLZ-1000ZS manufactured by OTSUKA ELECTRONICS CO., LTD). The conductive polymer dispersion liquid A was diluted 50 times by weight with pure water, and the measurement was performed at a wavelength of 660 nm, a scattering angle of 15°, and a temperature of 25° C. using a quartz cell. The obtained data was analyzed using a cumulant method (Levenberg-Marquardt method), and the particle diameter was calculated. Here, the particle diameter of the conductive polymer is d50 (median diameter) in the number distribution.

Next, 1 ml of the conductive polymer dispersion liquid A was dropped on a glass plate and dried in a drying furnace at 150° C. for 30 minutes to obtain a polymer film A.

### Water Absorption Amount

The obtained polymer film A was cut out, left in a thermo-hygrostat oven under an environment of 85° C. and 85% RH for 24 hours, and then taken out from the thermo-hygrostat oven, and a test piece was scraped off with a spatula. The obtained test piece was placed into a simultaneous thermogravimetric analyzer (STA7200, manufactured by Hitachi High-Technologies Corporation), the temperature was increased from 25° C. to 150° C. at a rate of 10° C./min, and a weight change of the test piece was measured. The water absorption amount (%) was determined based on the weights of the test piece before heating and at 150° C. according to the following equation (1).

$$Water absorption amount ( \% ) = ( ( weight before heating ) - ( weight at 150 °C . ) ) / ( weight at 150 °C . ) \times 100 \qquad Equation ( 1 )$$

### Contact Angle

To the polymer film A obtained by the same method as described above, 10 μL of pure water was added dropwise, and a contact angle θ with respect to water was measured. Specifically, assuming that a shape of a water droplet on the polymer film A in a plan view was a perfect circle, the contact angle θ was determined based on a radius r of the perfect circle and a height h of the water droplet according to the equation θ=2 arctan (h/r) (θ/2 method).

### Sheet Resistance

1 ml of the conductive polymer dispersion liquid A was dropped on a glass plate so as to be 2.0 cm×2.0 cm and dried in a drying furnace at 150° C. for 30 minutes to obtain the polymer film A. The sheet resistance (Ω/□) of the obtained polymer film A was measured by a four-probe method using a resistivity meter (Loresta-GP MCP-T610 manufactured by Mitsubishi Chemical Corporation).

Table 1 shows the composition of the conductive polymer dispersion liquid A, and the measurement results of the particle diameter of the conductive polymer, the water absorption amount, the contact angle with respect to water, and the sheet resistance of the polymer film A obtained from the conductive polymer dispersion liquid A.

### Experimental Examples 2 to 8

Conductive polymer dispersion liquids B to G having different compositions from the conductive polymer dispersion liquid A were prepared, and the same operations and measurements as in Experimental Example 1 were performed. Further, an aqueous solution obtained by dissolving self-doping type PEDOT in water was prepared as a conductive polymer solution H, and the water absorption amount, the contact angle, and the sheet resistance were measured by the same methods as in Experimental Example 1. Table 1 shows the compositions and the evaluation results of the conductive polymer dispersion liquids and the conductive polymer solutions.

TABLE 1

| | | Conductive | Conductive | Conductive | Conductive |
|---|---|---|---|---|---|
| | | polymer | polymer | polymer | polymer |
| | | dispersion | dispersion | dispersion | dispersion |
| | | liquid A | liquid B | liquid C | liquid D |
| Composition | PEDOT/PSS | 2 | 3 | 3 | 3 |
| (mass %) | Copolymer of PEDOT/styrenesulfonic | — | — | — | — |
| | acid and N-(hydroxymethyl)acrylamide | | | | |
| | Self-doping type PEDOT | — | — | — | — |
| | Ethylene glycol | 3 | 3 | — | 3 |
| | Polyester resin | 2 | 1 | — | — |
| | Acrylic resin | — | — | — | — |
| | Water | 93 | 93 | 94 | 94 |
| Measurement | Particle diameter (d50 in number | 15 | 5.6 | 2.7 | 15.3 |
| result | distribution) [nm] | | | | |
| | Water absorption amount [%] | 19.7 | 34.1 | 50.2 | 51.1 |
| | contact angle [°] with respect | 16.3 | 10.2 | 8.5 | 8.6 |
| | to water | | | | |
| | Sheet resistance [Ω/□] | 32 | 63 | 100 | 73 |
| | Thickness of the sample on which sheet | 10.8 | 10.3 | 9.5 | 10.0 |
| | resistance was measured [μm] | | | | |
| | | Conductive | Conductive | Conductive | |
| | | polymer | polymer | polymer | Conductive |
| | | dispersion | dispersion | dispersion | polymer |
| | | liquid E | liquid F | liquid H | solution H |
| Composition | PEDOT/PSS | 3 | 2 | — | — |
| (mass %) | Copolymer of PEDOT/styrenesulfonic | — | — | 3 | — |
| | acid and N-(hydroxymethyl)acrylamide | | | | |
| | Self-doping type PEDOT | — | — | — | 2 |
| | Ethylene glycol | — | 3 | 3 | — |
| | Polyester resin | 1 | — | — | — |
| | Acrylic resin | — | 2 | — | — |
| | Water | 96 | 93 | 94 | 98 |
| Measurement | Particle diameter (d50 in number | 3.8 | 12.3 | 17.5 | — |
| result | distribution) [nm] | | | | |
| | Water absorption amount [%] | 28.5 | 20.5 | 25.5 | 38.6 |
| | contact angle [°] with respect | 11.5 | 15.9 | 14.7 | 14.7 |
| | to water | | | | |
| | Sheet resistance [Ω/□] | 151 | 41 | 66 | 51 |
| | Thickness of the sample on which | 10.7 | 10.1 | 10.6 | 9.3 |
| | sheet resistance was measured [μm] | | | | |

### Production of Solid Electrolytic Capacitor (Example 1)

A solid electrolytic capacitor according to Example 1 was produced by the following steps 1 to 6.

### Step 1: Formation of Capacitor Element

First, a fine tantalum powder having a specific charge of about 1,500,000 μFV/g was compressed using a powder pressing machine to obtain a pressed body having a substantially rectangular parallelepiped shape having a length of 2.5 mm, a width of 1.5 mm, and a thickness of 0.6 mm in which a tantalum wire having a diameter of 0.19 mm was embedded. Note that, a direction along a longitudinal direction of the tantalum wire is a length direction of the pressed body. A length of the tantalum wire protruding from a surface of the pressed body was 5.0 mm. The obtained pressed body was sintered in an inert gas at 1300° C. to obtain a porous sintered body of the fine tantalum powder. Using the obtained sintered body of the fine tantalum powder as a valve metal, the sintered body was anodized at 15 V in a phosphoric acid aqueous solution at 85° C. to obtain a capacitor element (anode body) in which a dielectric oxide film layer made of tantalum oxide was formed on the entire surface of the sintered body of the fine tantalum powder. In the following description, a capacitor element having some layer or terminal formed on the surface may also be simply referred to as a “capacitor element”.

### Step 2: Chemical Polymerization

Next, the capacitor element obtained in the step 1 was immersed in a methanol solution of ferric p-toluenesulfonate as an oxidant and a dopant for 10 minutes, then taken out from the solution, and dried at room temperature for 30 minutes (step 2-a). Next, the capacitor element was immersed in a thiophene derivative (3,4-ethylenedioxythiophene) as a monomer for 1 minute, then taken out from the solution, and held at room temperature for 30 minutes to polymerize 3,4-ethylenedioxythiophene (step 2-b). Thereafter, the capacitor element was immersed in ethanol to wash the unreacted product and the oxidant residue (step 2-c). A series of polymerization operations including the above step 2-a (filling with an oxidant), step 2-b (polymerization of 3,4-ethylenedioxythiophene), and step 2-c (washing) were repeated six times in total to obtain a capacitor element having a first conductive polymer layer (chemically polymerized layer) formed on the surface thereof, the first conductive polymer layer being made of poly(3,4-ethylenedioxythiophene) (PEDOT) doped with p-toluenesulfonic acid.

### Step 3: Formation of Barrier Layer

The capacitor element obtained in the step 2 was immersed in the conductive polymer dispersion liquid A for 1 minute, pulled up, and then dried at 150° C. for 30 minutes. Accordingly, a capacitor element having a barrier layer formed on the first conductive polymer layer was obtained.

### Step 4: Electrolytic Polymerization

The capacitor element obtained in the step 3 was immersed in a solution containing 3,4-ethylenedioxythiophene and sodium organic sulfonate, and a stainless steel wire (diameter: 1.0 mm) as a power supply terminal was externally disposed to be in contact with the capacitor element. Electrolytic polymerization was performed by applying a DC voltage of 3 V or less using the power supply terminal side as an anode. Accordingly, a capacitor element having a second conductive polymer layer (electrolytically polymerized layer) formed on the barrier layer was obtained.

### Step 5: Formation of Cathode Layer

The capacitor element obtained in the step 4 was immersed in a graphite paste for 1 minute, pulled up, and then dried at 120° C. for 1 hour to form a carbon layer on the second conductive polymer layer. Further, the capacitor element was immersed in a silver paste for 1 minute, pulled up, and then dried at 120° C. for 1 hour to form a silver layer on the carbon layer. The stacked structure of the carbon layer and the silver layer is the cathode layer.

### Step 6: Electrode Attachment and Mold

In the capacitor element obtained in the step 5, a valve metal lead and an anode-side electrode were connected to each other by welding. In addition, the silver layer and a cathode-side electrode were connected to each other using a conductive adhesive. Finally, an exterior resin was formed on the capacitor element using a molding press to obtain a solid electrolytic capacitor in Example 1.

### Examples 2 to 8

Solid electrolytic capacitors in Examples 2 to 8 were obtained in the same manner as in Example 1 except that, in the step 3, the conductive polymer dispersion liquids B to G and the conductive polymer solution H were used instead of the conductive polymer dispersion liquid A during the formation of the barrier layer.

### Example 9

A solid electrolytic capacitor in Example 9 was obtained in the same manner as in Example 1 except that only about half of the capacitor element was immersed in the conductive polymer dispersion liquid A in the step 3 in order to change the barrier layer coverage.

### Example 10

A solid electrolytic capacitor in Example 10 was obtained in the same manner as in Example 1 except that the capacitor element was immersed in a primer solution (5 mass % 1,10-decanediamine aqueous solution) for 1 minute and dried at 125° C. for 30 minutes to perform a primer treatment after the step 2 and before the step 3.

### Examples 11 to 14

Solid electrolytic capacitors in Examples 11 to 14 were obtained in the same manner as in Example 1 except that in order to change the thickness of the barrier layer, in the step 3,the number of repetitions of the step of immersing in the conductive polymer dispersion liquid A for 1 minute and the number of repetitions of the step of drying for 30 minutes were changed to 3, 5, 10, and 15, respectively.

### Example 15

A solid electrolytic capacitor in Example 15 was obtained in the same manner as in Example 1 except that the step 3 was not performed and the barrier layer was not formed.

### Example 16

A solid electrolytic capacitor in Example 16 was obtained in the same manner as in Example 1 except that the number of repetitions of the step 2-a to the step 2-c was 10 in the step 2, the steps 3 and 4 were not performed, and the barrier layer and the electrolytically polymerized layer were not formed.

The coverage, the withstand voltage, the equivalent series resistance (ESR), and the surface roughness of the capacitor elements of the solid electrolytic capacitors in Examples 1 to 16 were evaluated.

### Coverage

After the formation of the barrier layer in the step 3 was completed and before the step 4 was performed, the appearance of the barrier layer formed on five surfaces of each capacitor element excluding the surface from which the tantalum wire protruded was photographed using an optical microscope (VHX-5000 manufactured by Keyence Corporation). The photographs taken were stored in a bitmap format. The stored photographs were imported into spreadsheet software (Microsoft Excel) in a binary data format, and pixel information of the image was extracted from the binary data. The pixel information was converted into gray scale using a luminance method. A histogram was created based on the gray scale values, and a binarization threshold value was determined using a mode method. The image was binarized with the determined threshold value, a barrier layer covering portion on the capacitor element was defined as black, and an uncovered portion thereof was defined as white. The coverage of the barrier layer was determined based on a ratio of pixels determined to be black to an outer surface area of the capacitor element. Note that, the outer surface area of the capacitor element here is not an actual surface area in consideration of a pore of the capacitor element which is a porous body, but a surface area when the capacitor element is viewed as a rectangular parallelepiped with the pore ignored.

### Withstand Voltage

Each capacitor was placed in a thermostatic chamber at 85° C., and a current value was measured when a DC voltage was applied while increasing the voltage at a rate of 1 V/sec. The voltage when the current value exceeded 200 mA was defined as the withstand voltage (V).

### Equivalent Series Resistance (ESR)

For each capacitor, the equivalent series resistance (ESR) at 100 kHz was measured using an LCR meter (4263B LCR METER, manufactured by Hewlett Packard Company).

### Surface Roughness

After the silver layer was formed in the step 5 and before the step 6 was performed, the surface roughness of the capacitor element was measured. Specifically, a line roughness was measured at three different locations on the surface of the capacitor element on which the silver layer was formed using a three-dimensional measuring machine (VR-6100, manufactured by Keyence Corporation), and the surface line roughness Ra (μm) was obtained from the average of the three measurements.

Tables 2 and 3 show the evaluation results of the solid electrolytic capacitors in Examples 1 to 16.

TABLE 2

| | | Example | Example | Example | Example | Example | Example | Example | Example |
|---|---|---|---|---|---|---|---|---|---|
| | | 1 | 2 | 3 | 4 | 5 | 6 | 7 | 8 |
| Preparation | Conductive polymer dispersion | A | B | C | D | E | F | G | H |
| method | liquid/solution (A to H) | | | | | | | | |
| | Slurry/times of solution | 1 | 1 | 1 | 1 | 1 | 1 | 1 | 1 |
| | application | | | | | | | | |
| | Primer treatment | No | No | No | No | No | No | No | No |
| | Electrolytically polymerized layer | Yes | Yes | Yes | Yes | Yes | Yes | Yes | Yes |
| Evaluation | Barrier layer thickness [μm] | 0.9 | 0.8 | 0.7 | 0.9 | 0.9 | 1.0 | 0.9 | 0.9 |
| result | Barrier layer coverage [%] | 84.6 | 71.5 | 28.1 | 83.9 | 83.5 | 82.5 | 84.6 | 61.8 |
| | Withstand voltage [V] | 17.4 | 16.5 | 13.2 | 17.4 | 17.4 | 17.4 | 17.4 | 16.3 |
| | Equivalent series resistance (ESR) | 55.4 | 56.3 | 73.9 | 211.3 | 201.6 | 55.7 | 56.8 | 56.3 |
| | [mΩ] | | | | | | | | |
| | Surface line roughness Ra [μm] | 1.926 | 2.886 | 8.112 | 9.631 | 2.484 | 1.941 | 2.337 | 2.114 |

TABLE 3

| | | Example | Example | Example | Example | Example | Example | Example | Example |
|---|---|---|---|---|---|---|---|---|---|
| | | 9 | 10 | 11 | 12 | 13 | 14 | 15 | 16 |
| Preparation | Conductive polymer dispersion | A | A | A | A | A | A | — | — |
| method | liquid/solution (A to H) | | | | | | | | |
| | Slurry/times of solution | 1 | 1 | 3 | 5 | 10 | 15 | 0 | 0 |
| | application | | | | | | | | |
| | Primer treatment | No | Yes | No | No | No | No | No | No |
| | Electrolytically polymerized layer | Yes | Yes | Yes | Yes | Yes | Yes | Yes | No |
| Evaluation | Barrier layer thickness [μm] | 0.9 | 1.0 | 3.0 | 8.1 | 20.1 | 30.6 | 0 | 0 |
| result | Barrier layer coverage [%] | 51.0 | 97.1 | 97.6 | 100 | 100 | 100 | 0 | 0 |
| | Withstand voltage [V] | 15.7 | 18.7 | 18.7 | 18.7 | 18.6 | 18.7 | 13.4 | 18.7 |
| | Equivalent series resistance (ESR) | 55.4 | 55.4 | 53.6 | 54.1 | 60.9 | 301.5 | 55.4 | 55.6 |
| | [mΩ] | | | | | | | | |
| | Surface line roughness Ra [μm] | 2.011 | 1.922 | 1.931 | 1.902 | 1.895 | 1.884 | 3.154 | 5.103 |

In Tables 2 and 3, Examples 1, 2, and 5 to 13 are Inventive Examples, and Examples 3, 4, 15, and 16 are Comparative Examples. As seen from comparison between Example 1 and Example 15 shows that the withstand voltage is improved by providing the barrier layer. As seen from Examples 1 to 3 and 9 to 12, the higher the coverage of the barrier layer, the higher the withstand voltage. As seen from Examples 1 and 10 to 14, the smaller the thickness of the barrier layer, the smaller the equivalent series resistance.

Note that, in the case of forming a barrier layer having low hydrophobicity as in Examples 3 and 4, the surface line roughness Ra is deteriorated due to swelling of the barrier layer, but in the case of a barrier layer in which an attempt for improving the hydrophobicity is made as in Examples 1, 2, 5, 6, and 7, swelling can be prevented and deterioration of the surface roughness can be prevented. Here, examples of methods for improving the hydrophobicity of the barrier layer include, but are not limited to, a method of using a hydrophobic anion having a long-chain alkyl group or phenyl group as a dopant, and a method of adding a hydrophobic binder resin to the dispersion liquid.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following embodiments and their equivalents.

What is claimed is:

1. A solid electrolytic capacitor, comprising:
a porous anode body including a valve metal and a dielectric oxide film layer formed on a surface of the valve metal; and
an electrolyte layer formed on a surface of the dielectric oxide film layer, wherein the electrolyte layer includes
a first conductive polymer layer formed by chemical polymerization and in contact with the dielectric oxide film layer,
a second conductive polymer layer formed by electrolytic polymerization and formed on a side opposite to the dielectric oxide film layer with respect to the first conductive polymer layer, and
a barrier layer having conductivity and formed between the first conductive polymer layer and the second conductive polymer layer, and
the barrier layer is configured to prevent a conductive polymer layer from being formed by electrolytic polymerization in a region closer to the porous anode body than the barrier layer.

2. The solid electrolytic capacitor according to claim 1, wherein the barrier layer is formed by applying and drying a conductive polymer dispersion liquid or a conductive polymer solution.

3. The solid electrolytic capacitor according to claim 2, wherein a particle diameter d50 in a number distribution of a conductive polymer contained in the conductive polymer dispersion liquid is 5 nm or more.

4. The solid electrolytic capacitor according to claim 1, wherein the barrier layer has a water absorption amount of 50 mass % or less in an atmosphere at a temperature of 85° C. and a humidity of 85% RH for 24 hours.

5. The solid electrolytic capacitor according to claim 2, wherein the barrier layer has a water absorption amount of 50 mass % or less in an atmosphere at a temperature of 85° C. and a humidity of 85% RH for 24 hours.

6. The solid electrolytic capacitor according to claim 1, wherein a ratio of an area where the barrier layer is formed to an area of a surface of the porous anode body where the electrolyte layer is formed is 50% or more.

7. The solid electrolytic capacitor according to claim 2, wherein a ratio of an area where the barrier layer is formed to an area of a surface of the porous anode body where the electrolyte layer is formed is 50% or more.

8. The solid electrolytic capacitor according to claim 1, wherein the first conductive polymer layer is subjected to a primer treatment.

9. The solid electrolytic capacitor according to claim 2, wherein the first conductive polymer layer is subjected to a primer treatment.

10. The solid electrolytic capacitor according to claim 2, wherein a sheet resistance of a film obtained by applying and drying the conductive polymer dispersion liquid or the conductive polymer solution used for forming the barrier layer is 100 Ω/□ or less.

11. The solid electrolytic capacitor according to claim 1, wherein the barrier layer has a thickness of 30 μm or less.

12. The solid electrolytic capacitor according to claim 2, wherein the barrier layer has a thickness of 30 μm or less.

13. The solid electrolytic capacitor according to claim 1, further comprising:
a carbon layer formed on the second conductive polymer layer; and
a silver layer formed on the carbon layer, wherein
the silver layer has a surface line roughness Ra of 3.0 μm or less.

14. The solid electrolytic capacitor according to claim 2, further comprising:
a carbon layer formed on the second conductive polymer layer; and
a silver layer formed on the carbon layer, wherein
the silver layer has a surface line roughness Ra of 3.0 μm or less.

15. A method for producing a solid electrolytic capacitor, comprising:
forming a first conductive polymer layer on a surface of a porous anode body by chemical polymerization, the porous anode body including a valve metal and a dielectric oxide film layer formed on a surface of the valve metal;
forming a barrier layer having conductivity on the first conductive polymer layer; and
forming a second conductive polymer layer on the barrier layer by electrolytic polymerization.
